(19) United States
(12) Patent Application Publication
(10) Pub. No.: US 2016/0088711 A1
(43) Pub. Date: Mar. 24, 2016

(54) ADAPTABLE LIGHTING SYSTEM

(71) Applicant: Systech Electronics Limited, Kwun Tong (HK)

(72) Inventors: Chun Sum NG, Kowloon (HK); Siu On LEE, Kowloon (HK)

(21) Appl. No.: 14/852,069

(22) Filed: Sep. 11, 2015

Related U.S. Application Data
(60) Provisional application No. 62/052,331, filed on Sep. 18, 2014.

(51) Int. Cl. H05B 37/02; G01J 1/42

(52) U.S. Cl. CPC H05B 37/0218; G01J 1/4204; H05B 37/0272

(57) ABSTRACT

The present disclosure relates to an adaptable lighting system and a method for adaptive illumination. An example adaptable lighting system comprises an image sensor configured to acquire environmental information associated with a plurality of predetermined regions; a microcontroller configured to calculate an illumination algorithm based on the acquired environmental information, and to generate an adjustment command based on the calculation; and one or more lighting units configured to receive the adjustment command, and to adjust lighting output in accordance with the received adjustment command. An example method for adaptive illumination comprises acquiring, by an image sensor, environmental information associated with a plurality of predetermined regions; calculating, by a microcontroller, an illumination algorithm based on the acquired environmental information; generating, by the microcontroller, an adjustment command based on the calculation; and adjusting lighting output of one or more lighting units in accordance with the generated adjustment command.

### CROSS-REFERENCE TO RELATED APPLICATION

This application claims priority from U.S. Provisional Ser. No. 62/052,331, filed on Sep. 18, 2014, entitled ADAPTABLE LIGHTING SYSTEM, which is hereby incorporated by reference in its entirety for all purposes.

### BACKGROUND

1. Field

The present disclosure relates to an adaptable lighting system, and more particularly to a lighting system lighting output of which is adjusted with the aid of an image sensor.

2. Related Art

Modern lighting apparatuses are apparatuses with electric light sources for lighting. The most basic control of a lighting apparatus is to turn it on and off. This can be achieved manually or automatically, e.g., at predefined times with the aid of a timer, or in response to a change in the noise level or illumination level with the aid of a sound detector or light sensor (such as a photocell or phototransistor) connected to the light source. The same control mechanisms can be applied to adjust the brightness or illumination level provided by the lighting apparatus.

Current mechanisms to automatically control the brightness of a lighting apparatus have several disadvantages. A lighting apparatus controlled using a timer is obviously unable to respond to the change of environmental illumination. This defect is not cured by the use of a light sensor because a light sensor can only detect the illumination of the small space near the light sensor itself. This is particularly problematic for lighting apparatuses with a large illumination area, because illumination of the small space near a single light sensor may not be representative of the illumination of the entire area for which the lighting apparatus is intended. One could use multiple light sensors to ameliorate this problem but it is costly and laborious to design the arrangement and to set up the multiple light sensors, thereby rendering this solution impracticable. Therefore, the use of light sensors can result in either lack of adequate illumination when it is needed or unnecessary illumination. Inadequate illumination can result in serious safety risks, while unnecessary illumination results in unnecessary power usage, excessive heat generation, and more frequent replacement of the light sources due to unnecessary operation time.

Another disadvantage associated with the use of light sensors in connection with the control of the brightness of lighting apparatuses is that light sensors are often times not good enough for the intended purpose, either because they have a narrow dynamic range of detection or because their level of detection is not sensitive enough. For example, when the ambient illumination falls below a certain level, light sensors may fail to respond to any change in the ambient illumination. Even if the ambient illumination falls within a light sensor's range of detection, small changes in the ambient illumination may not be captured by the light sensor due to sensitivity issue, resulting in the light apparatus's failure to respond to the changes.

### BRIEF SUMMARY

Some of the technical problems to be solved by embodiments of the present disclosure include lack of adequate illumination or unnecessary illumination associated with the use of light sensors in connection with lighting apparatuses, and the narrow dynamic range of detection and low sensitivity of such light sensors. To solve these technical problems, the present disclosure provides an adaptable lighting system and a method for adaptive illumination.

According to some embodiments, the adaptable lighting system of the present disclosure can comprise an image sensor configured to acquire environmental information associated with a plurality of predetermined regions, a microcontroller configured to calculate an illumination algorithm based on the acquired environmental information, and to generate an adjustment command based on the calculation, and one or more lighting units configured to receive the adjustment command, and to adjust lighting output in accordance with the received adjustment command.

According to some embodiments, the image sensor can be configured to acquire environmental information associated with a plurality of predetermined regions, each corresponding to a set of one or more lighting units, and the adjustment command comprises a command to adjust lighting output of the sets of lighting units corresponding to the plurality of predetermined regions.

According to some embodiments, the adaptable lighting system can further comprise a control configured to receive a user setting, wherein the microcontroller is configured to generate the adjustment command in accordance with the user setting.

According to some embodiments, the adaptable lighting system can also comprise a wireless control configured to wirelessly receive information, and to transmit the wirelessly received information to the microcontroller.

According to some embodiments, the microcontroller can be configured to calculate the illumination algorithm by comparing the environmental information to a user setting.

According to some embodiments, the one or more lighting units can comprise light-emitting diodes (LEDs), light bulbs, light tubes, or flood lights.

According to some embodiments, the adaptable lighting system can further comprise a device configured to display the acquired environmental information.

According to some embodiments, the method for adaptive illumination of the present disclosure can comprise: acquiring, by an image sensor, environmental information associated with a plurality of predetermined regions; calculating, by a microcontroller, an illumination algorithm based on the acquired environmental information; generating, by the microcontroller, an adjustment command based on the calculation; and adjusting lighting output of one or more lighting units in accordance with the generated adjustment command.

According to some embodiments, the method for adaptive illumination can further comprise receiving a user setting, wherein the adjustment command is generated in accordance with the user setting.

According to some embodiments, the method for adaptive illumination can also comprise receiving wirelessly, by a wireless control, the acquired environmental information from the image sensor, and transmitting, by the wireless control, the environmental information received from the image sensor to the microcontroller.

According to some embodiments, calculating an illumination algorithm can comprise comparing the environmental information to a user setting.

According to some embodiments, the method for adaptive illumination can further comprise displaying, by a device, the acquired environmental information.

According to some embodiments, the method for adaptive illumination can also comprise analyzing the acquired environmental information.

### BRIEF DESCRIPTION OF THE DRAWINGS

FIG. 1 illustrates an exemplary lighting system of the present disclosure.

FIG. 2 illustrates a second exemplary lighting system of the present disclosure.

FIG. 3 illustrates exemplary applications for the lighting system of the present disclosure.

FIG. 4 illustrates an exemplary configuration of a lighting array.

FIG. 5 illustrates an exemplary remote light meter.

FIG. 6 illustrates a second exemplary remote light meter.

FIG. 7 illustrates an exemplary configuration of multiple communication methods for interfacing with the lighting system of the present disclosure.

FIG. 8 illustrates an exemplary process for performing brightness control using the lighting system of the present disclosure.

FIG. 9 illustrates an exemplary process for achieving a brightness level by actuation of a user switch.

FIG. 10 illustrates an exemplary process for achieving a brightness level by wireless reception of a user command.

FIG. 11 illustrates an exemplary process utilizing an array statistic engine for achieving a desired brightness level.

FIG. 12 illustrates an exemplary process for interfacing with the lighting system of the present disclosure via a remote device.

### DETAILED DESCRIPTION

The following description is presented to enable a person of ordinary skill in the art to make and use the various embodiments. Descriptions of specific systems, devices, methods, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

An image sensor is a device that converts an optical image into an electronic signal. It is used mostly in digital cameras, camera modules and other imaging devices. Early analog sensors were video camera tubes; currently used types are semiconductor charge-coupled devices (CCD) or active pixel sensors in complementary metal-oxide-semiconductor (CMOS) or N-type metal-oxide-semiconductor (NMOS, Live MOS) technologies.

An image sensor has a number of advantages over light sensors when used in connection with a lighting apparatus. For example, it has a much wider range of area of detection than those of light sensors, and its area of detection can be controlled. As opposed to the limited physical space near a light sensor, an image sensor's area of detection is only limited by the area of the optical image that can be taken by an optical lens. For example, the optical lens can be configured to take an optical image of a very large area or of a focused small area. The present disclosure describes the application of image sensors to the control of the lighting output of a light source. According to some embodiments, an optical image of a large area which is intended to be illuminated can be processed by a single image sensor, thereby achieving the proper adjustment of the illumination of the entire area. According to some other embodiments, an optical image of a small area below the range of detection of a light sensor can be processed by an image sensor, thereby achieving focused illumination of the small area. As a result, image sensors are more versatile than light sensors when used in combination with lighting apparatuses.

Another exemplary advantage of the use of an image sensor over light sensors in controlling the lighting output of a lighting apparatus is the ability to separately analyze the illumination of different zones of a same image. This makes it possible to separately control the illumination of the different zones using a single image sensor to provide appropriate lighting level in the desired zone(s). This can result in energy conservation by illuminating only those zones that need illumination.

Yet another exemplary advantage of the use of an image sensor over light sensors in controlling the brightness of a lighting apparatus is related to the wider range of light detection and more sensitive light detection provided by image sensors, such that the brightness level of the lighting systems of the present disclosure can be controlled in ambient illumination conditions where such control is not achievable by light sensors, e.g., when the ambient illumination falls outside a light sensor's range of detection or when a small change of ambient illumination is expected to trigger a change of the illumination provided by the lighting apparatus.

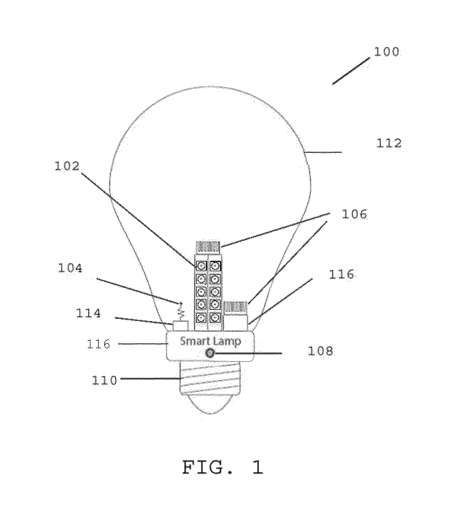

Referring first to FIG. 1, an exemplary lighting system of the present disclosure is shown. Lighting system 100 includes lighting array 102, microcontroller 116, and wireless control 114 attached to a first side of base 116. Protector 112 is attached to base 116 and encloses lighting array 102, microcontroller 116, wireless control 114, and antenna 104. Connector 110 is attached to a second side of base 116 that is opposite to the first side of base 116. Image sensor 108 is attached to a sidewall of base 116 between the first side and the second side of base 116.

Lighting array 102 extends from the first side of base 116 and includes a plurality of lighting units. According to some embodiments, lighting array 102 comprises a plurality of light-emitting diodes (LEDs). According to some other embodiments, the lighting array comprises a plurality of light bulbs. According to yet some other embodiments, the lighting array comprises a plurality of light tubes. According to still some other embodiments, the lighting array comprises a plurality of flood lights.

According to some embodiments, image sensor 108 comprises a charge-coupled device (CCD) or a complementary metal-oxide-semiconductor (CMOS). Image sensor 108 can be positioned such that light output from lighting array 102 is not directly projected onto image sensor 108. Image sensor 108 can be configured to acquire environmental information from one or more predetermined regions. The one or more predetermined regions can be positioned with respect to lighting system 100. According to some embodiments, image sensor 108 can be configured to acquire environmental information from a first predetermined region of the one or more predetermined regions. The first predetermined region can correspond to a first set of lighting units of the plurality of lighting units. In particular, the first set of lighting units can be positioned such that light output from the first set of lighting units is directed towards the first predetermined region. According to these embodiments, image sensor 108 can also acquire environmental information from a second predetermined region of the one or more predetermined regions. The second predetermined region can correspond to a second set of lighting units of the plurality of lighting units. In particular, the second set of lighting units can be positioned such that light output from the second set of lighting units is directed towards the second predetermined region. Based on the number of lighting units within lighting array 102, image sensor 108 can acquire additional environmental information based on a respective number of additional sets of lighting units. As used herein, “environmental information” means any information that may be acquired by an image sensor. Examples of environmental information that can be acquired by image sensor 108 include, but are not limited to, illumination data, lighting intensity, brightness data, contrast data, and color temperature information. A “predetermined region” is an area from which an image sensor has been configured to acquire environmental information. Methods of configuring an image sensor to acquire environmental information from one or more predetermined regions are well-known to those skilled in the art.

Microcontroller 116 can comprise a processor, e.g., a CPU. According to some embodiments, microcontroller 116 is configured to analyze acquired environmental information and calculate an illumination algorithm based on the acquired environmental information. Microcontroller 116 can transmit a command for adjusting lighting output based on the calculation. Adjusting lighting output, as used herein, refers to any means by which the lighting output of one or more lighting units of lighting array 102 can be changed. Examples of adjusting lighting output include, but are not limited to, turning on or off one or more lighting units, changing the lighting intensity of the one or more lighting units, changing the area or direction of illumination of one or more lighting units, and changing the lighting pattern of lighting units within a lighting array.

Protector 112 can be configured to provide good protection to the other components of lighting system 100 by providing a hard cover. Examples of the materials for the protector can include, but are not limited to, hard polymer and glass. According to some embodiments, protector 112 can comprise a coating to provide an even diffusion of light output from the lighting system into a surrounding environment.

Wireless control 114 can include antenna 104. Wireless control 114 can be configured to receive information from a wireless device via antenna 104, such as environmental information, a command to adjust lighting output or a user setting. According to some embodiments, the microcontroller can be configured to receive information via wireless control 114. Examples of received information can include, but are not limited to, environmental information, user commands, user settings, or adjustment commands.

Lighting system 100 can further comprise heat sinks 106, which can be coupled to either lighting array 102 or microcontroller 116, or both. Heat sinks 106 can be configured to release heat generated by the coupled components in order to prevent overheating of lighting system 100.

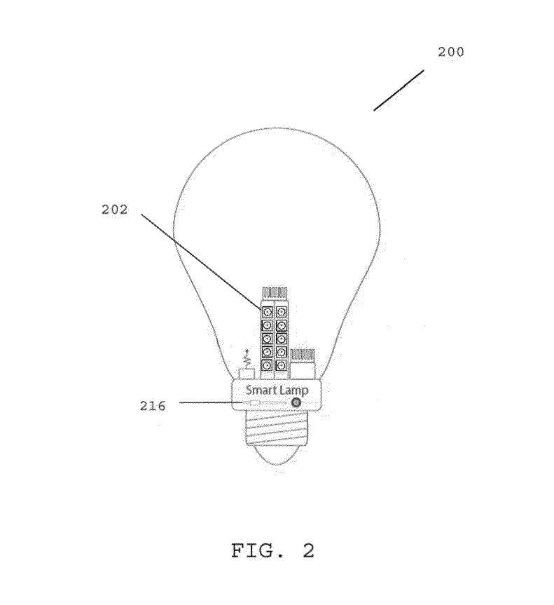

FIG. 2 illustrates another example of a lighting system of the present disclosure. Lighting system 200 includes the same or similar components to that of lighting system 100 of FIG. 1. Lighting system 200 additionally comprises control 216 (illustrated in FIG. 2 as a manual switch/button). According to some embodiments, control 216 can be configured to allow a user to manually adjust lighting output. According to some other embodiments, control 216 can be configured to allow a user to generate an adjustment command. According to some embodiments, control 216 can be configured to allow a user to generate or adjust a command to manage color temperature of the lighting array 202. As such, “control” is not to be interpreted to include simple on/off functions only. Rather, it refers to any mechanism by which a user can manually override the commands of the microcontroller. In particular, a user can use control 216 manually override the default lighting output or automatic adjustment of the lighting output of the lighting system of the present disclosure, either on a temporary basis or on a permanent basis.

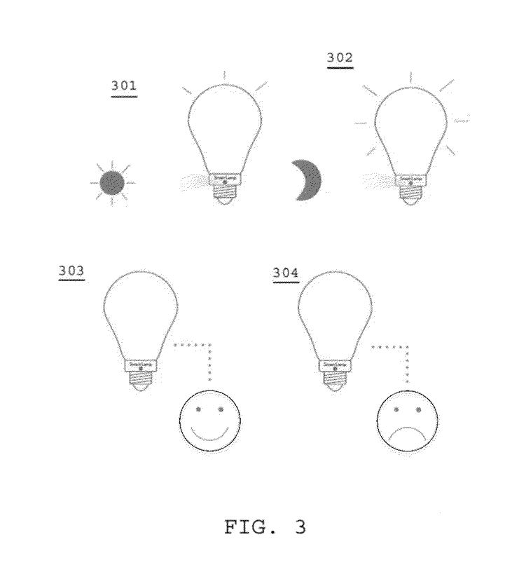

FIG. 3 illustrates exemplary applications for the lighting system of the present disclosure. In environment 301, the lighting system detects and receives environmental information, e.g., a high level of brightness and/or a color temperature consistent with sunlight. Based on the detected environmental information, the lighting system is configured to output a first level of brightness. In environment 302, the lighting system detects a change in environmental information from that of environment 301, e.g., a low level of brightness and/or a color temperature consistent with a lack of sunlight. Based on the detected environmental information from environment 302, the lighting system can be configured to output a second level of brightness. As illustrated in FIG. 3 and by way of example only, the second level of brightness output by the lighting system is higher than the first level of brightness.

In environment 303, the lighting system receives a first user light temperature command. The first user light temperature command can include light temperature consistent with a warm color. Based on the received first user light temperature command in environment 303, the lighting system can be configured to set a desired light temperature to the warm color. In environment 304, the lighting system detects a second user light temperature command. The second user light temperature command can include light temperature consistent with a cool color. Based on the received second user light temperature command in environment 304, the lighting system can be configured to adjust the desired light temperature to the cool color.

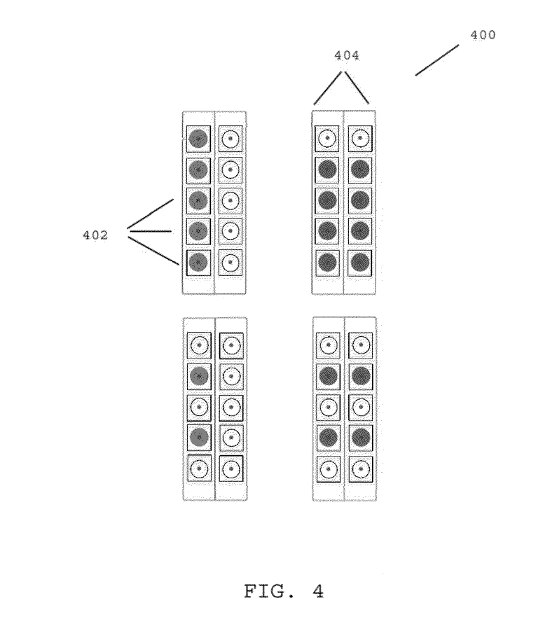

FIG. 4 illustrates an exemplary configuration of a lighting array. Lighting array 400 can include at least one row of lighting units 402. Lighting array 400 can further include at least one column of lighting units 404. In one example, lighting array 400 is configured to independently adjust lighting output for each individual lighting unit. In another example, lighting array 400 is configured to adjust lighting output for individual rows 402 simultaneously. In yet another example, lighting array 400 is configured to adjust lighting output for individual columns 404 simultaneously. Based on the lighting output applied to respective lighting units, the lighting array 400 can output unique lighting patterns. Lighting patterns may be preset by user commands, or may be output according to detected brightness of surrounding regions or other environmental information. In one example, individual lighting units may be associated with at least one predetermined region. Rows of lighting units 402 may be further associated with at least one predetermined region. Even further, columns of lighting units 404 may be associated with at least one predetermined region.

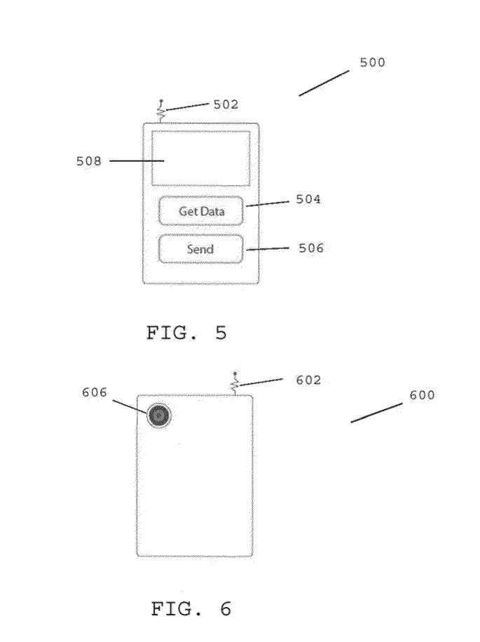

FIG. 5 illustrates an exemplary remote light meter. In one example, remote light meter 500 includes antenna 502, data button 504, send button 506, and user display 508. According to some embodiments, the remote light meter can be configured to receive a user input via data button 504. According to these embodiments, data button 504 is preferably not a single button but a series of buttons or keys that facilitate user input. In one example, a user may input a user setting, such as a desired brightness level, a desired light temperature, or a specific lighting pattern. In this example, send button 506 can be configured to transmit a command corresponding to the user setting via antenna 502 to a lighting system which can then change the brightness level or lighting pattern in accordance with the command. User display 508 can allow a user to view and modify (e.g., in the case where user display 508 is a touch screen) specific commands and settings. According to other embodiments, the remote light meter can be configured to receive environmental information acquired by an image sensor via data button 504. In one example, a user can, via antenna 502, remotely obtain environmental information acquired by an image sensor by pressing data button 504. In this example, user display 508 can allow a user to view the obtained environmental information. Send button 506 can be configured to transmit the obtained environmental information via antenna 502 to another device for further analysis.

FIG. 6 illustrates another exemplary remote light meter 600. Remote light meter 600 comprises image sensor 606 and antenna 602. Examples of image sensor 606 include, but are not limited to, CCD and CMOS. Image sensor 606 can acquire environmental information from a surrounding area, such as light intensity or color temperature. In one example, remote light meter 600 can be configured to periodically transmit acquired environmental information via antenna 602 to a lighting apparatus. In another example, remote light meter 600 can be configured to continuously transmit acquired environmental information via antenna 602 to a lighting apparatus. In these examples, the lighting apparatus can be configured to wirelessly receive the transmitted environmental information and adjust its lighting output in accordance with the received environmental information. In other words, according to some embodiments, the image sensor of the lighting system of the present disclosure does not need to be integrated with the light source (e.g., lighting array 102) but can communicate with the rest of the components of the lighting system wirelessly.

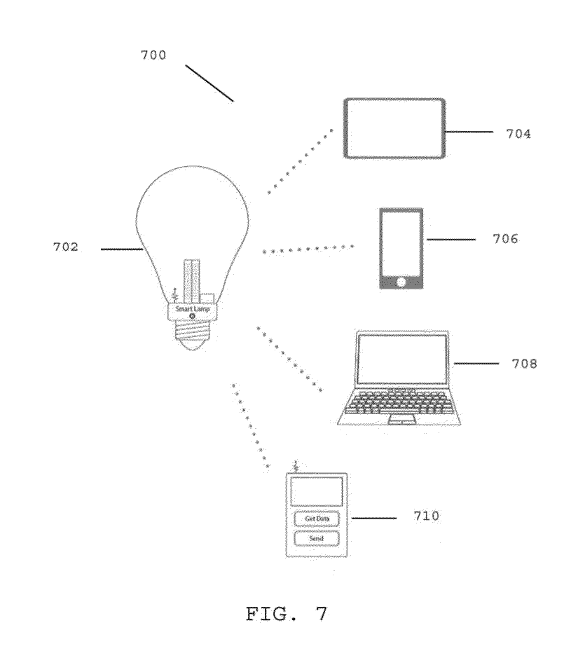

FIG. 7 illustrates an exemplary configuration 700 of multiple communication methods for interfacing with the lighting system. In one example, a user can utilize tablet device 704 to interface with lighting system 702. In another example, a use can utilize portable electronic device 706 to interface with lighting system 702. In yet another example, a user can utilize a portable or desktop computer 708 to interface with lighting system 702. In still another example, a user can interface with lighting system 702 by utilization of a remote light meter 710 such as the one illustrated in FIG. 5. It will be apparent to those skilled in the art that tablet devices, portable electronic devices and computers can provide more functionalities than the remote light meter illustrated in FIG. 5. They provide more platforms and thus more choices for users to control the lighting system of the present disclosure and/or to obtain the environmental information from the lighting system of the present disclosure. According to some embodiments, environmental information received by an end device such as a tablet device, a portable electronic device or a computer can be analyzed in the receiving end device without the need to be sent to another device for further analysis. Lighting system 702 can be configured to communicate with at least one of such end devices via wireless protocols well-known to those skilled in the art, such as IEEE specification 802.11, Bluetooth, and NFC. Design of software for the different platforms to be used with the lighting system of the present disclosure is also well-known to those skilled in the art.

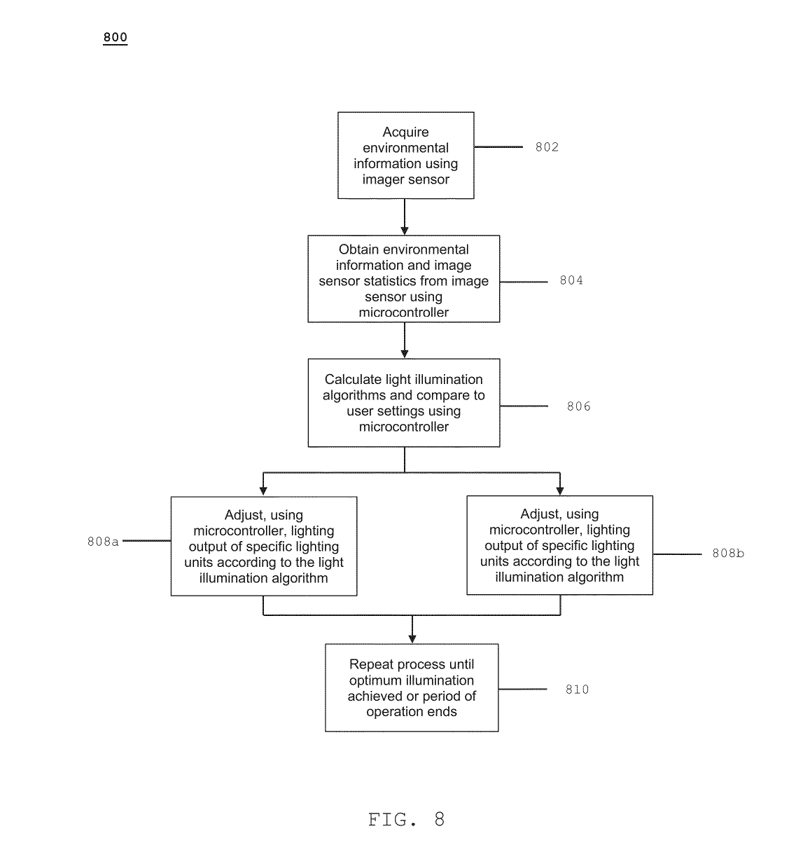

FIG. 8 illustrates an exemplary process 800 for performing brightness control using the lighting system. Process 800 may begin at block 802, where an image sensor may acquire environmental information of a specific predetermined region. In one example, the specific predetermined region may correspond to a predetermined pixel area of the image sensor, such as a region representing a predetermined number of pixels (e.g., four pixels by four pixels). In this example, environmental information acquired by the specified pixel area may correspond to the specific predetermined region. In another example, the specific predetermined region may include a predetermined physical area external to the lighting system, such as a region representing a predetermined square footage (e.g., two feet by two feet).

At block 804, the microcontroller can then obtain the environmental information from the image sensor together with other image sensor statistics. Examples of environmental information include, but are not limited to, brightness statistics and color temperature information. Examples of image sensor statistics include, but are not limited to, exposure statistics, current sensor exposure, and gain settings.

At block 806, the microcontroller can calculate a light illumination algorithm based on the obtained information. In one example, the calculation is compared to user settings. In another example, the calculation is compared to a target value.

According to some embodiments, process 800 can be configured to adjust global brightness settings based on the environmental information and resulting calculation. When configured to adjust global brightness settings, the microcontroller is configured to adjust all lighting units simultaneously upon calculating the illumination algorithm.

At block 808a, in accordance with the comparison, the microcontroller adjusts all lighting units by utilizing a dimming circuit to adjust lighting output at each lighting unit and changes the exposure settings of the image sensor.

According to some other embodiments, process 800 can be configured to adjust individual brightness settings based on the environmental detection and resulting calculation. When configured to adjust individual brightness settings, the microcontroller is configured to adjust specific row(s), column(s), or individual lighting units upon calculating the illumination algorithm. At block 808b, in accordance with the comparison, the microcontroller adjusts specific row(s), column(s), or individual lighting units and changes the exposure settings of the image sensor according.

Once process 800 adjusts brightness settings based upon the environmental detection and resulting calculation, the process continues until an optimum level of brightness is achieved in block 810. In one example, process 800 may repeat during a specified date and time. In another example, process 800 may repeat until the occurrence of an event, such as a user-generated trigger. In yet another example, process 800 may repeat until a target brightness value specified by the user is detected by the image sensor.

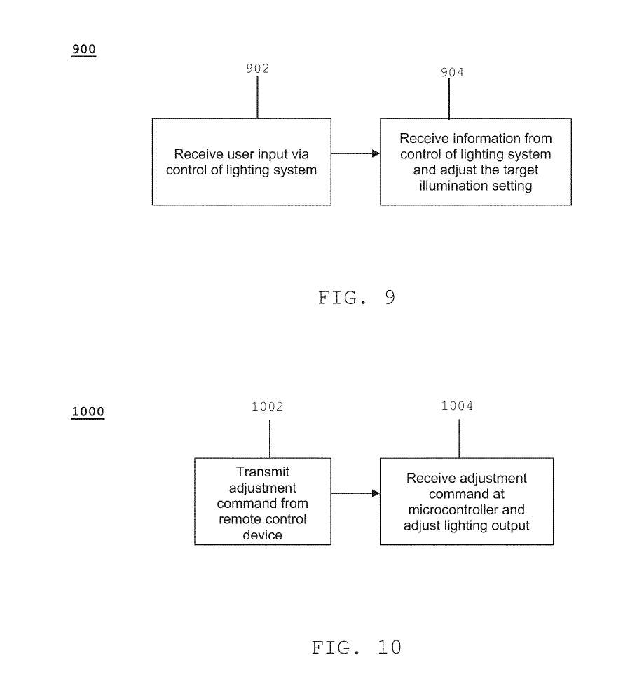

FIG. 9 illustrates an exemplary process 900 for achieving a brightness level by actuation of a user switch. At block 902, user input can be received via a control on the lighting system. For example, a user can actuate the control on the lighting system. In one example, the lighting system includes a slider control and the user input can include adjusting the position of the slider control to set a desired brightness level. In another example, the lighting system includes a switch control and the user input can include positioning the switch control to a specific position to achieve a desired brightness level.

At block 904, the microcontroller receives information regarding the resulting position of the actuation of the control. In one example, the microcontroller adjusts lighting output of specific lighting units based on the collected information. In another example, the microcontroller adjusts lighting output of all lighting units based on the collected information.

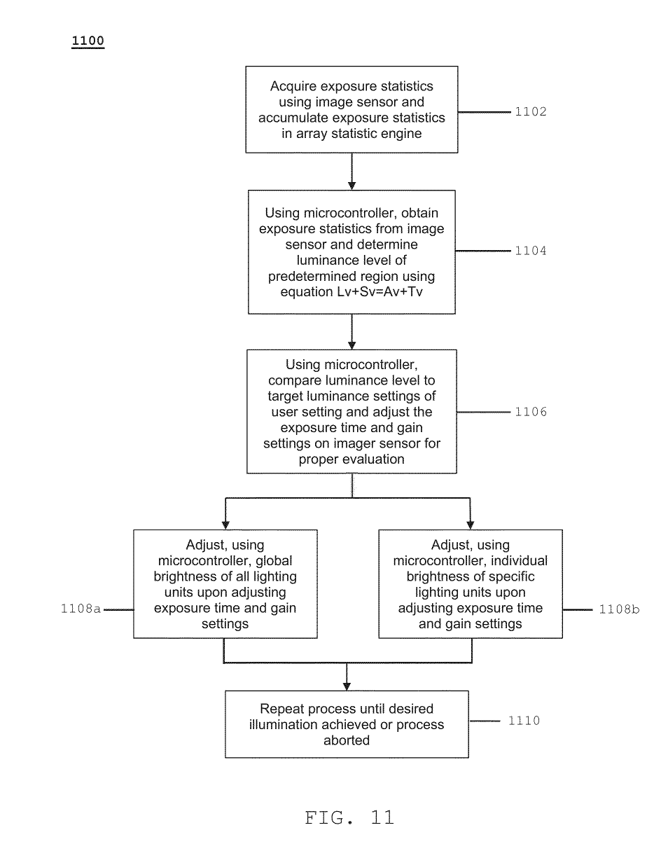

FIG. 10 illustrates an exemplary process 1000 for achieving a brightness level by wireless reception of a user command. At block 1002, a lighting output adjustment command is transmitted to the lighting system from a remote control device. In particular, user input defining user settings may be received at the remote control device and the adjustment command can represent the user settings. In one example, an adjustment command may be transmitted to the lighting system to set a desired brightness level. In another example, an adjustment command may be transmitted to the lighting system to set a desired color temperature level. In yet another example, the adjustment command may be a target brightness range to set a desired brightness range.

At block 1004, the microcontroller receives the lighting output adjustment command from the remote control device and adjusts the lighting output based on the received command. In one example, the microcontroller adjusts lighting output of specific lighting units based on the command. In another example, the microcontroller adjusts lighting output of all lighting units based on the command. In yet another example, the microcontroller sets a desired brightness range based on the command.

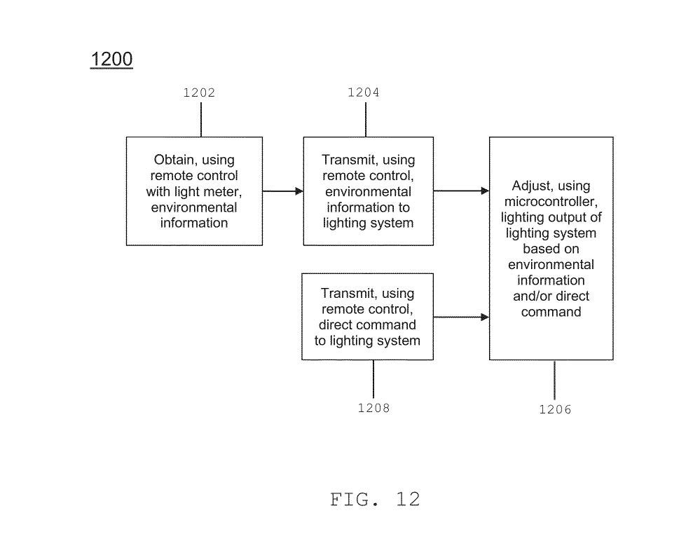

FIG. 11 illustrates an exemplary process 1100 utilizing an array statistic engine for achieving a desired brightness level. At block 1102, the image sensor can acquire exposure statistics through respective pixels of the image sensor, and then accumulate the exposure statistics in an array statistic engine.

At block 1104, the microcontroller can obtain the exposure statistics from the image sensor and determine the luminance level of at least one predetermined region. In one example, the microcontroller utilizes the equation Lᵥ+Sᵥ=Aᵥ+Tᵥ to obtain the luminance level of the at least one predetermined region. In block 1106, the microcontroller compares the obtained luminance levels to a target luminance setting of the user setting. Based on the comparison, the microcontroller adjusts exposure time and gain settings on the image sensor to facilitate proper evaluation.

According to some embodiments, process 1100 can be configured to adjust global brightness settings to obtain a constant level of illumination. When configured to adjust global brightness settings, the microcontroller is configured to adjust all lighting units simultaneously upon adjusting the exposure time and gain settings. At block 1108a, the microcontroller adjusts all lighting units based on continuous feedback from the image sensor. In one example, the process as illustrated in blocks 1102, 1104, 1106 and 1108a is continuously performed unless a desired condition is met, or a user aborts process 1100.

According to some other embodiments, process 1100 can be configured to adjust individual brightness settings to obtain an adaptive level of illumination. When configured to adjust individual brightness settings, the microcontroller is configured to adjust specific row(s), column(s), or individual lighting units upon adjusting the exposure time and gain settings. In block 1108b, the microcontroller adjusts specific row(s), column(s), or individual lighting units based on continuous feedback from the image sensor. The specific row(s), column(s), or individual lighting units may be less than all of the lighting units in the lighting array.

In some embodiments, the process as illustrated in blocks 1102, 1104, 1106 and 1108b is continuously performed until a desired illumination condition is met (e.g., based on user settings), or process 1100 is aborted (e.g., by the user). In particular, at block 1110, process 1100 may be repeated until a desired illumination condition is met or process 1100 is aborted.

FIG. 12 illustrates an exemplary process for interfacing with the lighting system via a remote device. At block 1202, a remote control with a light meter (e.g., by image sensor or ambient light sensor) obtains environmental information for a predetermined region using an integrated image sensor. In one example, the predetermined region may correspond to a specific pixel area of the image sensor. In particular, environmental information for the predetermined region may include environmental information obtained by a specific pixel area of the image sensor. The specific pixel area may be a region representing a predetermined number of pixels (e.g., four pixels by four pixels) of the image sensor. In another example, the predetermined region may include a predetermined physical area, such as a region representing a predetermined square footage (e.g., two feet by two feet) positioned with respect to the remote control.

At block 1204, the light meter of the remote control transmits the obtained environmental information (or corresponding user settings associated with obtained environmental information) to the lighting system over a wireless connection. Alternatively, at block 1208, the remote control may receive user input corresponding to target illumination settings. In these examples, the remote control may not have a light meter. The remote control may transmit a direct command to the lighting system over a wireless connection. In one example, the direct command may include illumination settings, such as one or more of a brightness setting, color temperature setting, or brightness pattern setting. At block 1206, the microcontroller adjusts lighting output of respective lighting units based on the received environmental information and/or user direct command.

Adaptable lighting systems described in the present disclosure have a wide range of applications. According to some embodiments, the lighting systems of the present disclosure can be used in residential lighting systems. For example, the lighting system can be installed near a garage, where the image sensor of the lighting system is configured to acquire the intensity of illumination of the driveway in front of the garage. When the illumination of the driveway falls below a predetermined level, one or more lighting units of the lighting system can be turned on and the lighting intensity of the one or more lighting units can be automatically adjusted in accordance with the change in the illumination level of the driveway. Another exemplary application involves the use of a remote light meter, which can be carried by a user, acquire environmental information close to the user, and transmit the acquired environmental information wirelessly to a microcontroller that generates adjustment commands in accordance with the acquired environmental information. This is particularly helpful when the user enters a dark room but does not know where the light switch is; instead of having to search and reach for the light switch, the remote light meter the user carries senses the darkness and the light(s) in the room can be switched on accordingly. According to some embodiments, the lighting systems of the present disclosure can be used in commercial lighting systems. One exemplary application is the automatic switching on or off of neon lights in response to changes in ambient illumination. In addition, different neon lights can be turned on in response to different ambient illumination levels so that different information can be displayed by merchants to customers at different times of the day or in response to different weather conditions. Another exemplary application of the lighting system of the present disclosure is the control of the lighting of large constructions (such as multi-storied parking lots), which has been known to be burdensome due to the number of lighting units (and their switches) to be installed and the need to turn those switches on or off at different times of the day. The lighting systems of the present disclosure can provide an automated way to control such lighting, with the aid of image sensors installed in security cameras. Such image sensors can be part of the lighting system of the present disclosure to control the lighting of those areas monitored by the security cameras. According to some other embodiments, when the images from different security cameras are displayed on a screen, such as one installed in a central control room, a single image sensor can acquire environmental information in connection with the displayed images and, via the lighting system of the present disclosure, remotely control the lighting of multiple locations. In these embodiments, the predetermined regions are the areas on the screen where individual images from the security cameras are displayed and not the areas actually monitored by those security cameras and in need of proper lighting. Therefore, according to such embodiments, the predetermined regions do not have to correspond to areas the lighting of which is affected by the lighting output of the lighting units of the present disclosure.

While specific components, configurations, features, and functions are provided above, it will be appreciated by one of ordinary skill in the art that other variations may be used. Additionally, although a feature may appear to be described in connection with a particular embodiment, one skilled in the art would recognize that various features of the described embodiments may be combined. Moreover, aspects described in connection with an embodiment may stand alone.

Although embodiments have been fully described with reference to the accompanying drawings, it should be noted that various changes and modifications will be apparent to those skilled in the art. Such changes and modifications are to be understood as being included within the scope of the various embodiments as defined by the appended claims.

What is claimed is:

1. An adaptable lighting system comprising:
an image sensor configured to acquire environmental information associated with a plurality of predetermined regions;
a microcontroller configured to calculate an illumination algorithm based on the acquired environmental information, and to generate an adjustment command based on the calculation; and
one or more lighting units configured to receive the adjustment command, and to adjust lighting output in accordance with the received adjustment command.

2. The lighting system of claim 1, wherein each predetermined region corresponds to a set of one or more lighting units, and the adjustment command comprises a command to adjust lighting output of the sets of one or more lighting units corresponding to the plurality of predetermined regions.

3. The lighting system of claim 1, further comprising a control configured to receive a user setting, wherein the microcontroller is configured to generate the adjustment command in accordance with the user setting.

4. The lighting system of claim 3, further comprising a wireless control configured to wirelessly receive information, and to transmit the wirelessly received information to the microcontroller.

5. The lighting system of claim 4, wherein the image sensor is configured to wirelessly transmits the acquired environmental information to the wireless control, and the wireless control is configured to transmit the acquired environmental information received wirelessly from the image sensor to the microcontroller.

6. The lighting system of claim 4, wherein the control is further configured to wirelessly transmit the user setting to the wireless control, wherein the wireless control is configured to transmit the user setting received wirelessly from the control to the microcontroller.

7. The lighting system of claim 3, wherein the microcontroller is configured to calculate the illumination algorithm by comparing the environmental information to the user setting.

8. The lighting system of claim 1, wherein the one or more lighting units comprise light-emitting diodes (LEDs), light bulbs, light tubes, or flood lights.

9. The lighting system of claim 1, further comprising a device configured to display the acquired environmental information.

10. The lighting system of claim 9, wherein the image sensor is configured to wirelessly transmits the acquired environmental information to the device.

11. A method for adaptive illumination, the method comprising:
acquiring, by an image sensor, environmental information associated with a plurality of predetermined regions;
calculating, by a microcontroller, an illumination algorithm based on the acquired environmental information;
generating, by the microcontroller, an adjustment command based on the calculation; and
adjusting lighting output of one or more lighting units in accordance with the generated adjustment command.

12. The method of claim 11, wherein each predetermined region corresponds to a set of one or more lighting units, and the adjustment command comprises a command to adjust lighting output of the sets of lighting units corresponding to the plurality of predetermined regions.

13. The method of claim 11, further comprising receiving a user setting, wherein the adjustment command is generated in accordance with the user setting.

14. The method of claim 13, further comprising receiving wirelessly, by a wireless control, the acquired environmental information from the image sensor, and transmitting, by the wireless control, the environmental information received from the image sensor to the microcontroller.

15. The method of claim 14, wherein receiving the user setting comprises receiving the user setting wirelessly by the wireless control, and the method further comprises transmitting, by the wireless control, the received user setting to the microcontroller.

16. The method of claim 13, wherein calculating the illumination algorithm comprises comparing the environmental information to the user setting.

17. The method of claim 11, wherein the one or more lighting units comprise light-emitting diodes (LEDs), light bulbs, light tubes, or flood lights.

18. The method of claim 11, further comprising displaying, by a device, the acquired environmental information.

19. The method of claim 18, further comprising transmitting wirelessly, from the image sensor to the device, the acquired environmental information.

20. The method of claim 11, further comprising analyzing the acquired environmental information.
